(19) United States
(12) Patent Application Publication
(10) Pub. No.: US 2015/0364975 A1
(43) Pub. Date: Dec. 17, 2015

(54) ROTOR WITH HEAT SINK

(71) Applicant: JOHNSON ELECTRIC S.A., Murten (CH)

(72) Inventors: James Ching Sik LAU, Hong Kong (CN); Ting HE, Shenzhen (CN); Cheong Wing YUEN, Hong Kong (CN); Yu Ying LI, Shenzhen (CN); Yang Qing HOU, Shenzhen (CN)

(21) Appl. No.: 14/741,115

(22) Filed: Jun. 16, 2015

(30) Foreign Application Priority Data
Jun. 16, 2014 (CN) 201410268616.7

(51) Int. Cl. H02K 9/22; H02K 9/04

(52) U.S. Cl. CPC H02K 9/22; H02K 9/04

(57) ABSTRACT

A rotor for an electric motor has a shaft, a rotor core and rotor windings. The rotor core is fixed to the shaft and has a number of teeth. A winding slot is formed between adjacent teeth. The rotor includes a heat sink made of a thermally conductive material. The heat sink includes two annular portions and a plurality of connecting members connecting the two annular portions. The annular portions are located at respective axial ends of the rotor core. The connecting members are disposed in respective winding slots and are thermally connected with the rotor windings.

### CROSS REFERENCE TO RELATED APPLICATIONS

This non-provisional patent application claims priority under 35 U.S.C. §119(a) from Patent Application No. 201410268616.7 filed in The People's Republic of China on Jun. 16, 2014, the entire contents of which are hereby incorporated by reference.

### FIELD OF THE INVENTION

This invention relates to motors and in particular, to a rotor for an electric motor, with an integral heat sink.

### BACKGROUND OF THE INVENTION

Brush motors include a rotor having a shaft, a commutator and rotor core fixed to the shaft, and rotor windings wound around teeth of the rotor core and electrically connected with segments of the commutator. During operation of the motor, the rotor windings generate heat. If the heat of the motor cannot be timely dissipated, the efficiency as well as the lifespan of the motor may be reduced.

### SUMMARY OF THE INVENTION

Thus, there is a desire for a motor with improved heat dissipation mechanism.

Accordingly, in one aspect thereof, the present invention provides a rotor for a motor, comprising a shaft, a rotor core fixed to the shaft and rotor windings wound on the rotor core, the rotor core comprising a plurality of teeth extending outwardly, a winding slot formed between adjacent teeth, effective parts of the rotor windings being disposed in the winding slots, and a heat sink made of a thermally conductive material, wherein the heat sink comprises two annular portions and a plurality of connecting members interconnecting the two annular portions, the two annular portions being located at respective axial ends of the rotor core, and the connecting members are received in respective winding slots and are thermally connected with the effective parts of the rotor windings.

Preferably, axial ends of the rotor windings are located at respective axial ends of the rotor core and are thermally connected with the annular portions of the heat sink.

Preferably, the heat sink is a monolithic structure formed on the rotor core and rotor windings.

Preferably, a radially outer most side of the connecting members of the heat sink are substantially flush with a radially outer most surface of the rotor core.

Alternatively, a radially outer most side of the connecting members of the heat sink and a radially outer most surface of the teeth of the rotor core are located on substantially the same circumferential surface.

Preferably, a commutator is fixed to the shaft, the commutator has a plurality of commutator segments arranged in a circumferential direction of the rotor, the commutator segments comprise connecting portions that are electrically connected with the rotor windings, and one of the annular portions of the heat sink further comprises an axial extension that extends over and thermally connects with the connecting portions.

Preferably, one of the annular portions of the heat sink further comprises a plurality of blades for generating airflow when the rotor rotates.

Preferably, the blades extend radially of the rotor and form a centrifugal fan.

Preferably, each blade is L-shaped and projects from an axial end surface of said corresponding annular portion in an axial direction of the rotor and projects from a radial surface of said corresponding annular portion in an radial direction of the rotor.

According to a second aspect, the present invention provides a motor comprising a rotor and a stator, the stator having a motor housing, and an end cap mounted to an open end of the motor housing, and the rotor comprising a shaft, a rotor core fixed to the shaft and rotor windings wound on the rotor core, the rotor core comprising a plurality of teeth extending outwardly, a winding slot formed between adjacent teeth, effective parts of the rotor windings being disposed in the winding slots, and a heat sink made of a thermally conductive material, wherein the heat sink comprises two annular portions and a plurality of connecting members interconnecting the two annular portions, the two annular portions being located at respective axial ends of the rotor core, and the connecting members are received in respective winding slots and are thermally connected with the effective parts of the rotor windings.

Preferably, the motor housing and/or end cap comprises through holes for the passage of air.

Preferably, axial ends of the rotor windings are located at respective axial ends of the rotor core and are thermally connected with the annular portions of the heat sink.

Preferably, the heat sink is a monolithic structure formed on the rotor core and rotor windings.

Preferably, a radially outer most side of the connecting members of the heat sink are substantially flush with a radially outer most surface of the rotor core.

Alternatively, a radially outer most side of the connecting members of the heat sink and a radially outer most surface of the teeth of the rotor core are located on substantially the same circumferential surface.

Preferably, the rotor has a commutator fixed to the shaft, the commutator comprises a plurality of commutator segments arranged in a circumferential direction of the rotor, the commutator segments comprise connecting portions that are electrically connected with the rotor windings, and one of the annular portions of the heat sink further comprises an axial extension that extends over and thermally connects with the connecting portions.

Preferably, one of the annular portions of the heat sink further comprises a plurality of blades for generating airflow when the rotor rotates, and the motor housing includes through holes aligned with the blades in the radial direction.

Preferably, a radially outer surface of the rotor and the stator form an air gap there between, and the motor housing has a through hole in communication with the air gap to thereby form a heat dissipating airflow passage.

Preferably, the stator further comprises a brush assembly disposed at one end of the motor housing, the brush assembly comprises brushes, and the motor housing has through holes corresponding to the brushes.

In view of the foregoing, in the rotor of the present invention, the heat sink is thermally connected with the rotor windings, which enhances the heat dissipating efficiency of the rotor windings and hence improves the heat dissipation of the rotor.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is a perspective view of a motor according to the preferred embodiment;

FIG. 2 is similar to FIG. 1, but viewed from another angle;

FIG. 3 illustrates the motor of FIG. 1, with an end cap removed;

FIG. 4 is a front view of the motor of FIG. 1;

FIG. 5 is a cross-sectional view of the motor FIG. 4, taken along line A-A thereof;

FIG. 6 is a sectional view of the motor of FIG. 4, taken along line B-B thereof;

FIG. 7 illustrates a rotor of the motor FIG. 1;

FIG. 8 is a perspective view of a heat sink of the rotor of FIG. 7; and

FIG. 9 is similar to FIG. 8, but viewed from another angle.

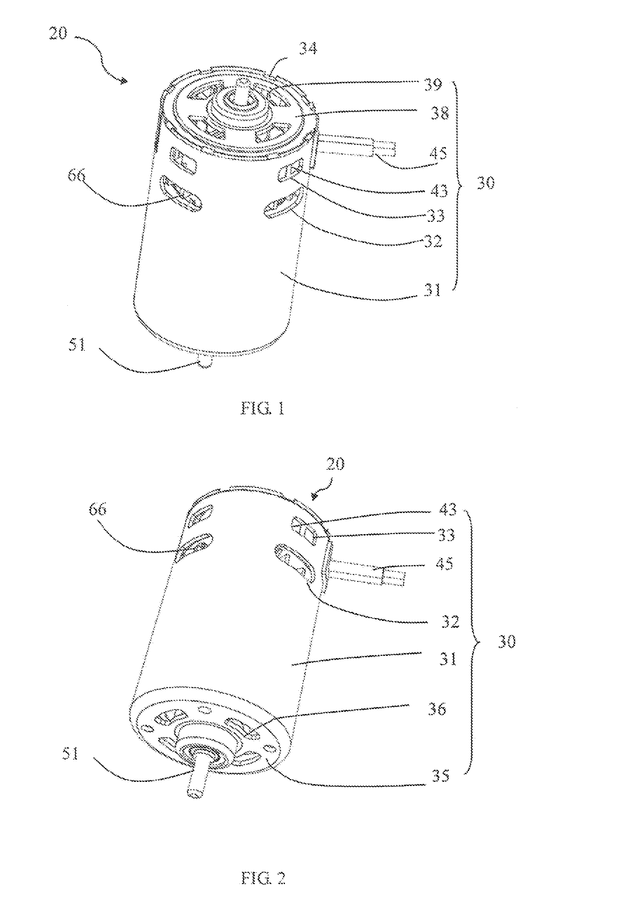

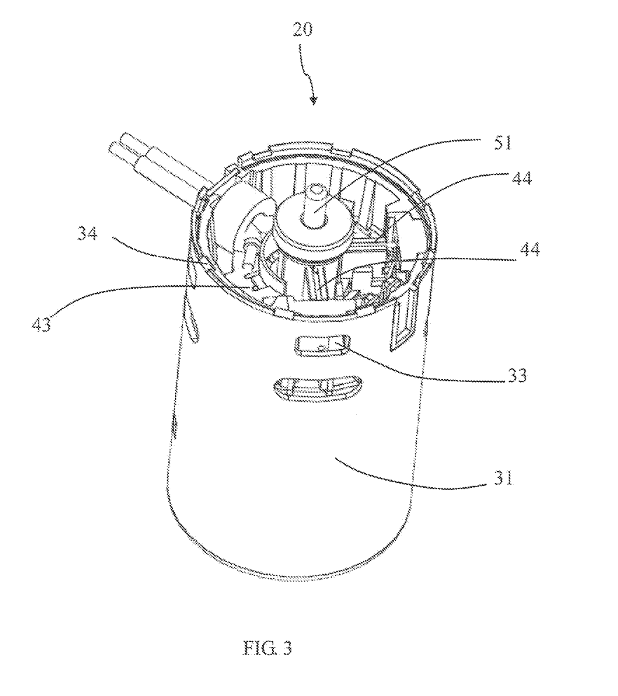

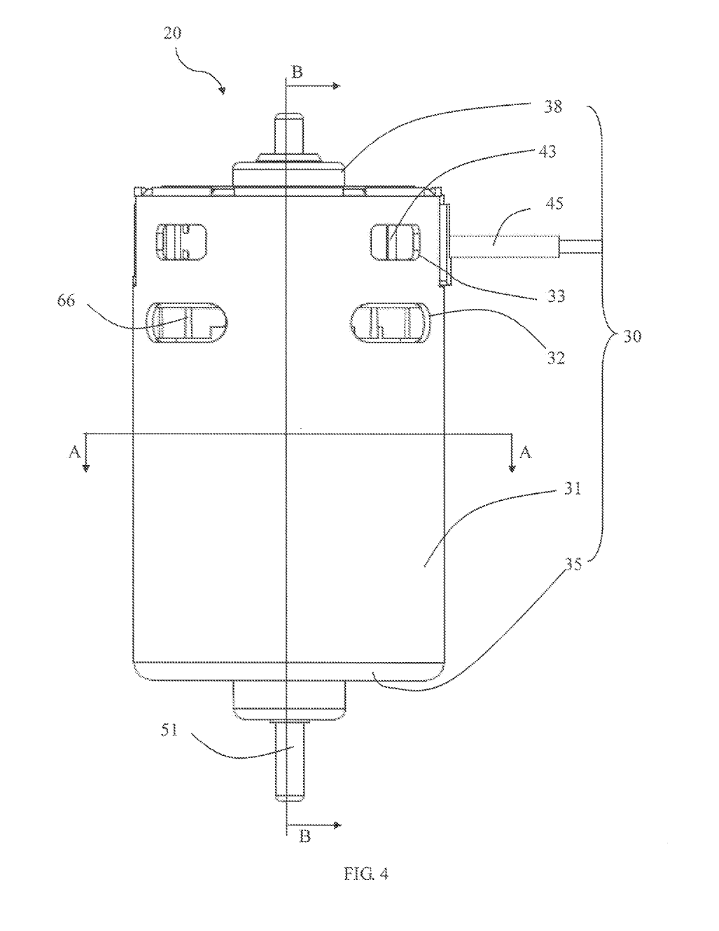

### DETAILED DESCRIPTION OF THE PREFERRED EMBODIMENTS

The Figures show a motor 20 in accordance with the preferred embodiment of the present invention. The motor is a permanent magnetic direct current (PMDC) brush motor. The motor 20 includes a stator 30 and a rotor 50.

The stator 30 includes a cylindrical motor housing 31 with an open end, four permanent magnets 41 mounted to an inner surface of the motor housing 31, and a brush assembly 43 and an end cap 38 mounted to the open end of the motor housing 31. Crimps or connecting tabs 34 are formed at the open end of the motor housing 31. After the end cap 38 is mounted, the connecting tabs 34 are bent inwardly to secure the end cap 38 to the motor housing 31. The motor housing 31 includes a bottom portion 35 at the other end thereof. The bottom portion 35 and the end cap 38 each form a bearing holder for mounting of bearings 47, 48. The brush assembly 43 includes at least one pair of brushes 44. The at least one pair of brushes 44 is connected with power cables 45 for connecting to an external power source.

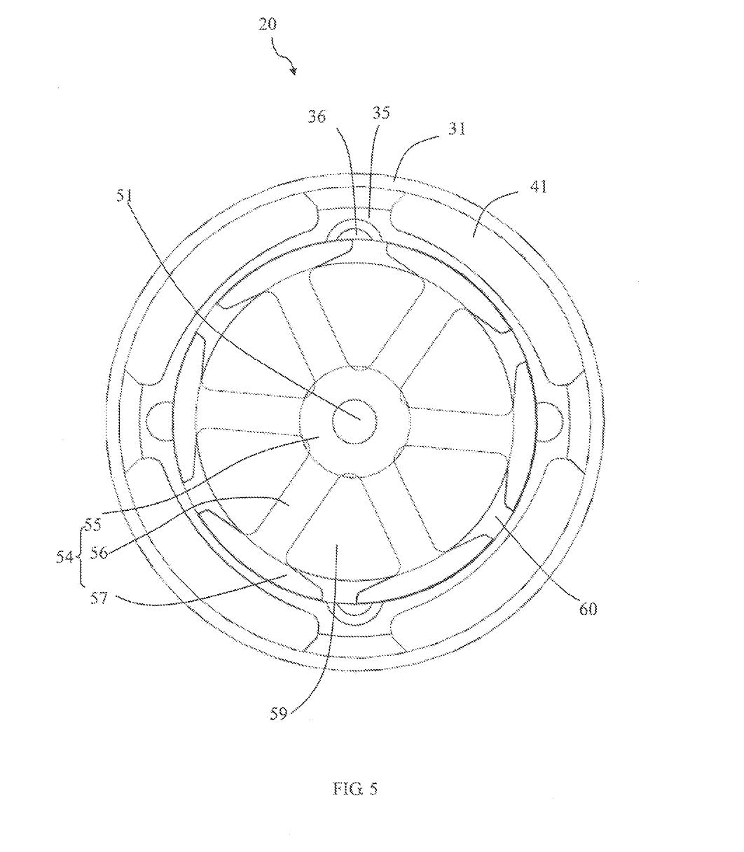

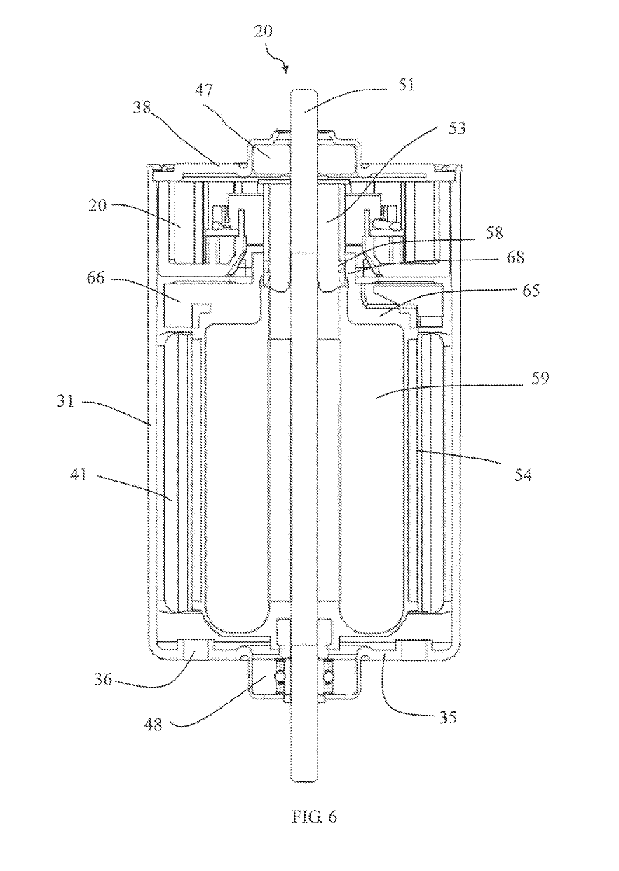

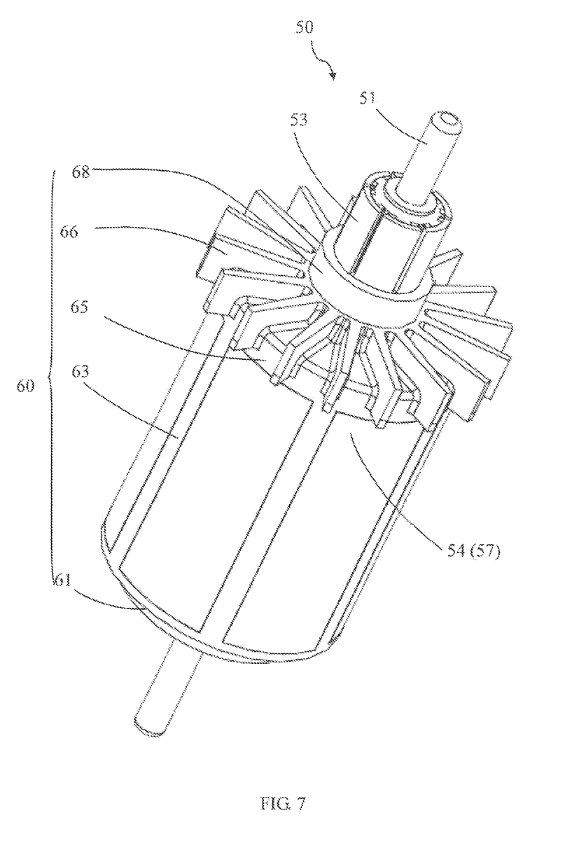

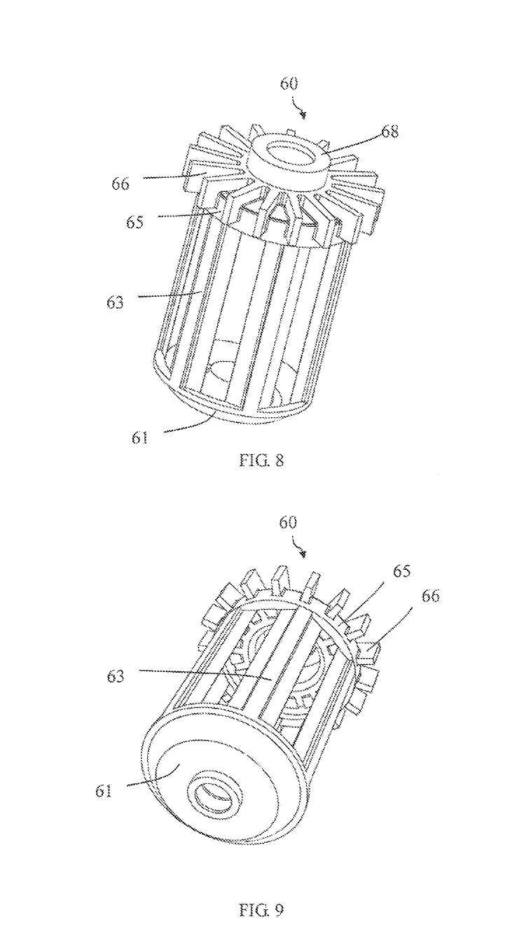

Referring to FIG. 5 to FIG. 7, the rotor 50 includes a shaft 51, a commutator 53 and a rotor core 54 fixedly mounted to the shaft 51, and rotor windings 59. The commutator 53 includes a plurality of commutator segments arranged along a circumferential direction of the shaft 51. The rotor core 54 includes a hub portion 55 and six teeth 56 extending radially from the hub portion 55. The six teeth are evenly distributed in the circumferential direction of the shaft 51, with winding slots formed between adjacent teeth 56. A pole shoe 57 is disposed at a radially outer end of each tooth 56. The pole shoes 57 face the permanent magnets 41 across an air gap to allow rotation of the rotor relative to the stator. Adjacent pole shoes 57 define a slot opening for a corresponding one of the winding slots. Effective parts of the rotor windings 59 are received in the winding slots, and ends of the rotor windings 59 are located at the axial ends of the rotor core 54. The rotor windings are electrically and physically connected to segments of the commutator. The rotor windings 59 can be connected to the commutator segments by crimp connections, welding, etc., to achieve an electrical connection there between. It is to be understood that the present invention can be used in motors having another number of teeth, permanent magnets and commutator segments. In addition, while the present invention is described above in connection with a PMDC brush motor, it is to be understood that it can also be used in rotors of other types of motors, such as a rotor of a universal motor.

The rotor 50 further includes a heat sink 60 made of a heat conductive material. The heat sink 60 includes two annular portions 61, 65 and a plurality of connecting members 63 connected between the two annular portions 61, 65. The two annular portions 61, 65 are disposed at the two axial ends of the rotor core 54 and are thermally connected with the ends of the rotor windings 59. The connecting members 63 are received in respective winding slots and are thermally connected with the effective parts of the rotor windings. In this embodiment, the heat sink 60 is made of electrically conductive plastic with a thermal conductivity equal to or greater than 1W/(mk), such as, PA6. The heat sink 60 is integrally formed over the rotor core by injection molding.

Preferably, the connecting members 63 fill the remaining space of the winding slots (i.e. the connecting members 63 and the effective parts of the rotor windings 59 together fill each of the winding slots). Because of the better thermal conductive performance of the connecting members 63 than air, the heat generated by the rotor windings 59 can be rapidly conducted away by the connecting members 63. In addition, because the connecting members 63 are disposed at an outer surface of the rotor windings, glue is not required to fix wires of the rotor windings 59 as in the traditional process.

Preferably, a radially outer most side of the connecting member 63 is substantially flush with the radially outer most end (pole shoe 57) of a corresponding adjacent tooth 56. More preferably, the radially outer most side of the connecting member 63 and the radially outer most surface of the rotor core are located on substantially the same circumferential surface. As such, the rotor has a smoother outer circumferential surface which reduces rotational resistance due to air friction.

It is noted that, during operation, segments of the commutator 53 also generate heat due to electrical current flowing there through and friction with the brushes. In this embodiment, the annular portion 65 of the heat sink 60 includes an axial extension 68 which extends toward the commutator 53 and has a reduced outer diameter. The axial extension 68 surrounds and thermally connects with tangs or connecting portions of the commutator segments that are connected with the windings 59, thereby rapidly conducting heat away from the commutator segments.

In this embodiment, the annular portion 65 of the heat sink further includes a plurality of blades 66 forming a centrifugal fan. During rotation of the rotor, the blades 66 generate airflow to expedite the heat dissipation of the heat sink 60. The blades 66 extend radially from the rotor. Each blade is L-shaped, and projects from an axial end surface of annular portion 65 in the axial direction of the rotor and projects from a radial surface of annular portion 65 in the radial direction of the rotor, thereby forming a centrifugal fan creating airflow over the rotor when the rotor rotates.

Preferably, the blades 66 are integrally formed on the annular portion 65 of the heat sink 60 that is adjacent the commutator 53, for more effectively dissipating heat from the commutator 53 and brush assembly 43, in particular, the brushes 44.

The motor housing 31 has through holes 32 corresponding to the blades 66 for exhausting the radial airflow from the fan to expedite heat dissipation. The bottom portion 35 of the motor housing 31 has through holes 36 and the end cap 38 has through holes 39. The through holes 36, 39 allow air to flow into the motor housing 31 in an axial direction to feed the fan and cool the rotor. The fan draws air over the commutator and brush assembly from holes 39 and draws air over the rotor core and magnets through the air gap between the stator and rotor from holes 36.

In addition, the motor housing 31 further includes through holes 33 aligned with the brushes 44 of the brush assembly 43 for facilitating heat dissipation of the brushes 44. Preferably, the through holes 33 of the motor housing 31 are in flow communication with the heat dissipating airflow generated by the blades 66 of the fan.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of example only, and various other modifications will be apparent to persons skilled in the field without departing from the scope of the invention as defined by the appended claims.

1. A rotor for a motor, comprising a shaft, a rotor core fixed to the shaft and rotor windings wound on the rotor core, the rotor core comprising a plurality of teeth extending outwardly, a winding slot formed between adjacent teeth, effective parts of the rotor windings being disposed in the winding slots, and a heat sink made of a thermally conductive material,
wherein the heat sink comprises two annular portions and a plurality of connecting members interconnecting the two annular portions, the two annular portions being located at respective axial ends of the rotor core, and the connecting members are received in respective winding slots and are thermally connected with the effective parts of the rotor windings.

2. The rotor of claim 1, wherein axial ends of the rotor windings are located at respective axial ends of the rotor core and are thermally connected with the annular portions of the heat sink.

3. The rotor of claim 1, wherein the heat sink is a monolithic structure formed on the rotor core and rotor windings.

4. The rotor of claim 1, wherein a radially outer most side of the connecting members of the heat sink are substantially flush with a radially outer most surface of the rotor core.

5. The rotor of claim 1, wherein a radially outer most side of the connecting members of the heat sink and a radially outer most surface of the teeth of the rotor core are located on substantially the same circumferential surface.

6. The rotor of claim 1, wherein the rotor further comprises a commutator fixed to the shaft, the commutator comprises a plurality of commutator segments arranged in a circumferential direction of the rotor, the commutator segments comprise connecting portions that are electrically connected with the rotor windings, and one of the annular portions of the heat sink further comprises an axial extension that extends over and thermally connects with the connecting portions.

7. The rotor of claim 1, wherein one of the annular portions of the heat sink further comprises a plurality of blades for generating airflow when the rotor rotates.

8. The rotor of claim 7, wherein the blades extend radially of the rotor and form a centrifugal fan.

9. The rotor of claim 7, wherein each blade is L-shaped and projects from an axial end surface of said corresponding annular portion in an axial direction of the rotor and projects from a radial surface of said corresponding annular portion in an radial direction of the rotor.

10. A motor comprising a rotor and a stator, the stator having a motor housing, and an end cap mounted to an open end of the motor housing, and
the rotor comprising a shaft, a rotor core fixed to the shaft and rotor windings wound on the rotor core, the rotor core comprising a plurality of teeth extending outwardly, a winding slot formed between adjacent teeth, effective parts of the rotor windings being disposed in the winding slots, and a heat sink made of a thermally conductive material,
wherein the heat sink comprises two annular portions and a plurality of connecting members interconnecting the two annular portions, the two annular portions being located at respective axial ends of the rotor core, and the connecting members are received in respective winding slots and are thermally connected with the effective parts of the rotor windings.

11. The motor of claim 10, wherein the motor housing and/or end cap comprises through holes for the passage of air.

12. The motor of claim 10, wherein axial ends of the rotor windings are located at respective axial ends of the rotor core and are thermally connected with the annular portions of the heat sink.

13. The motor of claim 10, wherein the heat sink is a monolithic structure formed on the rotor core and rotor windings.

14. The motor of claim 10, wherein a radially outer most side of the connecting members of the heat sink are substantially flush with a radially outer most surface of the rotor core.

15. The motor of claim 10, wherein a radially outer most side of the connecting members of the heat sink and a radially outer most surface of the teeth of the rotor core are located on substantially the same circumferential surface.

16. The motor of claim 10, wherein the rotor further comprises a commutator fixed to the shaft, the commutator comprises a plurality of commutator segments arranged in a circumferential direction of the rotor, the commutator segments comprise connecting portions that are electrically connected with the rotor windings, and one of the annular portions of the heat sink further comprises an axial extension that extends over and thermally connects with the connecting portions.

17. The motor of claim 10, wherein one of the annular portions of the heat sink further comprises a plurality of blades for generating airflow when the rotor rotates, and the motor housing includes through holes aligned with the blades in the radial direction.

18. The motor of claim 10, wherein a radially outer surface of the rotor and the stator form an air gap there between, and the motor housing has a through hole in communication with the air gap to thereby form a heat dissipating airflow passage.

19. The motor of claim 10, wherein the stator further comprises a brush assembly disposed at one end of the motor housing, the brush assembly comprises brushes, and the motor housing has through holes corresponding to the brushes.
